(19) United States
(12) Patent Application Publication
(10) Pub. No.: US 2022/0021803 A1
(43) Pub. Date: Jan. 20, 2022

(54) SERVICE VERIFICATION SYSTEM

(71) Applicant: Rehrig Pacific Company, Los Angeles, CA (US)

(72) Inventors: Jason Crawford Miller, Bedford, TX (US); Rahul Agarwal, Plano, TX (US); Robert Lee Martin, JR., Lucas, TX (US)

(21) Appl. No.: 17/379,214

(22) Filed: Jul. 19, 2021

Related U.S. Application Data
(60) Provisional application No. 63/053,268, filed on Jul. 17, 2020.

(51) Int. Cl. H04N 5/232; G06K 7/10

(52) U.S. Cl. CPC H04N 5/23218; G06K 7/10366

(57) ABSTRACT

A service verification system includes at least one collection truck including a hopper for receiving material and at least one camera positioned and oriented to image a container to be emptied into the hopper. At least one server receives images from the at least one camera. The collection truck may include an RFID reader configured to read RFID tags on containers to be emptied into the hopper. The server receives identification information from the RFID reader associated with the images from the camera. The images may be triggered upon the reading of the RFID tag, or by activation of a lift arm lifting the container, or manually by a driver.

### BACKGROUND

The collection of recycling, waste or compost material from thousands of commercial and residential properties is a significant logistical feat performed weekly by many municipalities or their contractors. Route optimization and monitoring the collection from each container have improved service levels. For example, many collection trucks read an RFID tag on each container being emptied into the truck to log the collection and the time of the collection. For one thing, this data can be used to optimize collection routes for each of the trucks and verify which containers were emptied. However, this does not verify containers on a route that were not emptied for one reason or another. Further, sometimes containers have improper contents, e.g. trash in a recycling cart.

### SUMMARY

A service verification system includes at least one collection truck including a hopper for receiving material and at least one camera positioned and oriented to image a container to be emptied into the hopper. At least one server receives images from the at least one camera.

The collection truck may include an RFID reader configured to read RFID tags on containers to be emptied into the hopper. The server receives identification information from the RFID reader associated with the images from the camera. The images may be triggered upon the reading of the RFID tag, or by activation of a lift arm lifting the container, or manually by a driver.

The server may provide a map display of a plurality of events. The events include collection of each of a plurality of containers, indications that a container is missing, indications that a container cannot be collected (e.g. blocked, overfilled, wrong contents).

The selectively displays the images from the at least one camera, such as via a browser to an administrator or supervisor. The images are each associated with an event. At least one of the images may show a container missing, or images of why a container cannot be collected (e.g. blocked, overfilled, wrong contents).

The server may also analyze multiple images taken over multiple collection periods (e.g. multiple weeks).

A method for collecting material from containers includes: a) reading an identifier on a first container; b) lifting the first container; c) transferring the material from the first container to a hopper on a truck; and d) capturing a first image of the first container based upon at least one of steps a) to c). The first image is associated with the first container.

At another location, a second image may be captured of a location where a second container is expected but missing. A gps location or address associates a profile or account with the missing container.

The image maybe captured based upon the activation of the lift arm emptying the material from the container. In this case, the first image may include at least a portion of the material from the first container.

A collection vehicle for use in the service verification system includes a hopper for receiving material. The hopper has an opening and an interior volume. An RFID reader is positioned proximate the opening to the hopper and is configured to read an RFID tag on a container to be emptied into the hopper. At least one camera is mounted on the vehicle. The at least one camera is positioned and oriented to image the container, either on the ground before/during being grasped, while being emptied, or the location where the container is expected to be but is missing. The at least one camera may be mounted exterior of the vehicle and may be positioned and oriented rearward of the vehicle.

The collection vehicle may include a CPU programmed to cause the at least one camera to image the container based upon the CPU receiving a signal indicating that the lift arm has tipped the container.

The collection vehicle may include a button activatable by a driver such that the at least one camera is configured to take an image based upon activation of the button. The at least one camera is positioned and oriented to image the container prior to being lifted into the hopper or to image an area where the container is expected to be if no container is present.

The at least one camera of the vehicle may be positioned and oriented to image the container and at least a portion of the interior volume of the hopper.

### BRIEF DESCRIPTION OF THE DRAWINGS

FIG. 1 shows a roll-out cart as one example of a container that can be used with service verification system.

FIG. 2 shows one embodiment of a service verification system using the container of FIG. 1 and a side-loading collection truck.

FIG. 3 shows the service verification system implemented with the container of FIG. 1 and a rear-loading collection truck.

FIG. 4 is a schematic of the on-board components of the collection trucks of FIGS. 2 and 3.

FIG. 5 shows a map display of events recorded by the service verification system.

FIG. 6 shows the map display of FIG. 5, with certain events selected to generate summary information windows.

FIG. 7 shows the map display of FIG. 6 with a first example image associated with a first event.

FIG. 8 shows the map display of FIG. 6 with a second example image associated with a second event.

### DETAILED DESCRIPTION

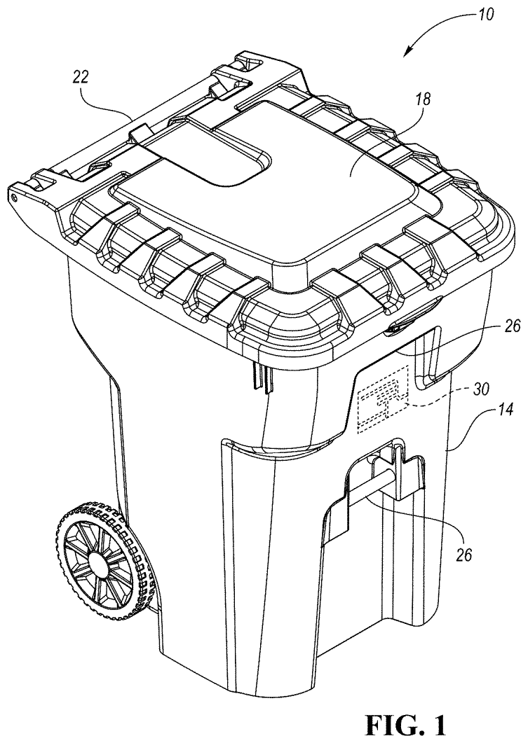

FIG. 1 illustrates an example roll-out cart 10 having a hollow body portion 14 coverable with a lid 18. A handle 22 hingeably connects the lid 18 to the hollow body portion 14. The roll-out cart 10 includes lift portions 26 and wheels 34. The roll-out cart 10 may be used for collecting recycling, trash, leaves, or other material.

The roll-out cart 10 includes an identifier 30 secured to the roll-out cart 10. In this example, the identifier 30 is a radio frequency identification (RFID) tag, such as passive RFID tag. Other types of radio, magnetic, optical, or electronic identifiers can also be used. The identifier 30 may be secured to an exterior surface of the body portion 14, in-molded during the injection molding process of the body portion 14 or lid 18, inserted within the handle, secured to an inner or outer surface of the lid 18 (using adhesive, for example), or secured to the cart 10 in any other suitable manner. The lid 18 and the hollow body portion 14 are typically injection molded from a polymer material such as High-Density Polyethylene (HDPE).

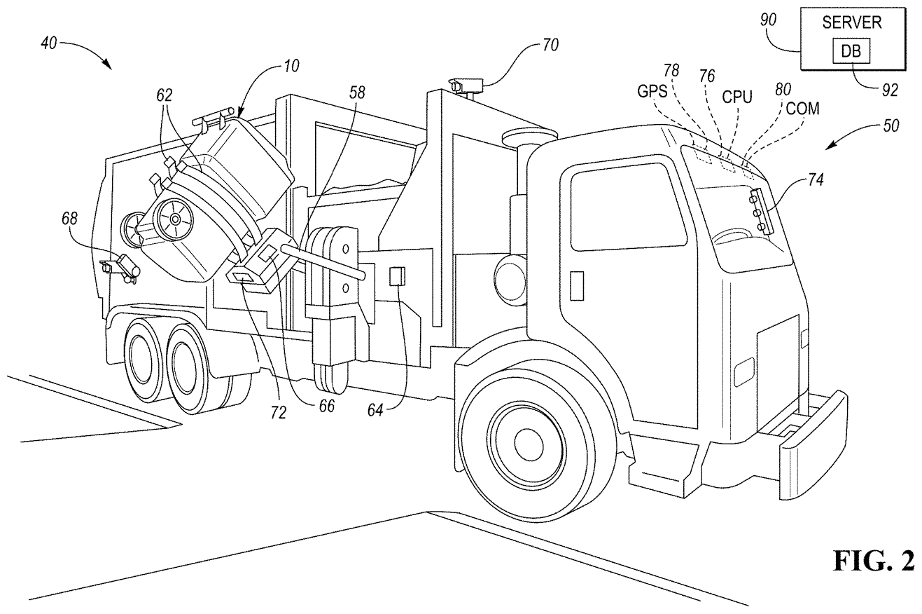

FIG. 2 shows one example of a service verification system 40 as implemented with the roll-out cart 10 of FIG. 1 and one type of collection vehicle, such as a collection truck 50. The service verification system 40 would include many such collection trucks 50 and/or other types of collection trucks. Each of the trucks 50 communicates with at least one server 90 having at least one processor and storage containing instructions which when executed by the processor perform the functions described herein. The storage also contains a database 92 having a plurality of profiles, each associating particular roll-out carts 10 (and/or other containers) as identified by their identifiers 30 (FIG. 1) with a particular account (e.g. for billing and communication purposes) as well as with a particular location, including an address and/or a specific lat/long where the roll-out cart 10 can be expected to be found on a collection day.

This example truck 50 has a lift arm 58 extendable from a side thereof and configured to lift and tip the roll-out cart 10 to empty the contents from the roll-out cart 10 into a first container or hopper 54. A pair of forks 62 extending from the lift arm 58 receive the roll-out cart 10 and maintain the position of the roll-out cart 10 relative to the lift arm 58 while lifting the roll-out cart 10 over the hopper 54. The lift arm 58 may alternatively grasp the lift portions 26 of the cart 10, or squeeze the body portion 14, as known. After the contents of the roll-out cart 10 are dumped into the hopper 54, the lift arm 58 returns the roll-out cart 10 to the collection location position adjacent the truck 50. Periodically, the contents of the hopper 54 are moved to a larger, second container of the truck 50.

The truck 50 may have an RFID reader 64 on the side of the truck 50 or an RFID reader 66 on the lift arm 58 (or, alternatively, both). The RFID readers 64, 66 are configured to read the identifier 30 on the cart 10. Of course, if identifiers 30 other than RFID tags are used, then appropriate readers would be used in place of RFID readers 64, 66.

The RFID reader 64 on the side of the truck 50 is configured to read the identifier 30 on the cart 10 as the cart 10 sits on the ground before being lifted by the lift arm 58. The RFID reader 66 on the lift arm 58 is configured to read the identifier 30 on the cart 10 as the cart 10 is grasped by the lift arm 58. Alternatively, or in addition, an RFID reader in or near the opening to the hopper 54 can read the identifier 30 on the cart 10 as the cart 10 is dumped into the hopper 54.

An exterior camera 68 is mounted exterior of the truck 50, such that it has a view of the cart 10 on the ground and the surrounding area before the cart 10 is grasped by the lift arm 58. An interior camera 70 faces a portion of the hopper 54 of the truck 50 (or out from the hopper 54) so that it has a view into the cart 10 as the lid 18 opens when the cart 10 is inverted by the lift arm 58 and into the hopper 54 so that the contents of the cart 10 are viewed by the interior camera 70 as the contents land in the hopper 54.

A tilt switch 72 may be mounted to the lift arm 58 to indicate when the lift arm 58 has tipped the cart 10 and emptied its contents into the hopper 54. An OBS button 74 in the cab of the truck 50 is accessible to the driver.

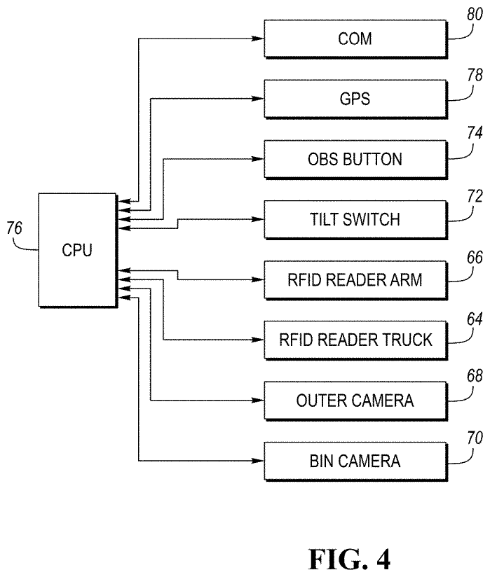

Referring to FIGS. 2 and 4, a CPU 76, suitably programmed, is mounted in the truck 50 and receives location information from a GPS receiver 78 and can communicate wirelessly via a communication circuit 80 (e.g. Bluetooth, wifi, and/or cell data, etc). The CPU 76 also receives information from the OBS button 74, the tilt switch 72, the RFID reader 64 on the side of the truck, the RFID reader 66 on the lift arm 58. The CPU 76 receives a signal from the OBS button 74 when the driver activates the OBS button 74. The CPU 76 receives a signal from the tilt switch 72 indicating that the lift arm 58 has tipped the cart 10. The CPU 76 receives the identifications from the RFID readers 64, 66. The CPU 76 also receives video and/or still images from the exterior camera 68 and the interior camera 70. The CPU 76 is programmed to receive, record, log (i.e. associate with date, time, address, lat/long) all of this information and periodically transmit it to the server 90 via the communication circuit 80.

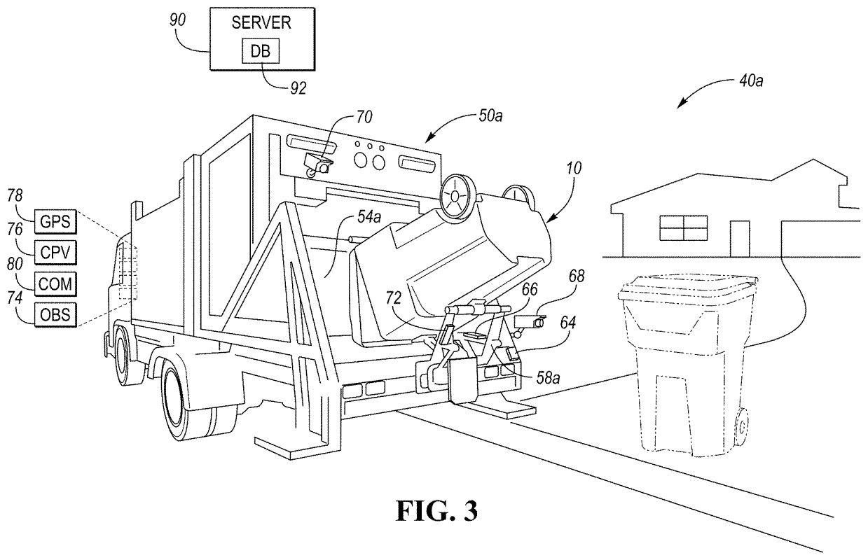

FIG. 3 shows another implementation of a service verification system 40a with the roll-out cart 10 of FIG. 1 and a second type of collection truck 50a. The service verification system 40a would include many such collection trucks 50a and/or the collection trucks 50 of FIG. 2, and/or other types of collection trucks. Each of the trucks 50a communicates with the server 90. Many of the same components of the service verification system 40 of FIG. 2 are installed in corresponding locations on the truck 50a, but positioned for a rear-loaded hopper 54a (a first container).

This example truck 50a has a rear lift arm 58a extendable therefrom and configured to lift and tip the roll-out cart 10 to empty the contents from the roll-out cart 10 into a rear hopper 54a. Periodically, the contents of the hopper 54a are moved to a larger container on the truck 50a, as is known.

The truck 50a may have the RFID reader 64 on the rear of the truck 50 or the RFID reader 66 on the lift arm 58a (alternatively, both could be used). The RFID reader 64 on the rear of the truck 50 is configured to read the identifier 30 on the cart 10 as the cart 10 sits on the ground before being lifted by the lift arm 58a. The RFID reader 66 on the lift arm 58a is configured read the identifier 30 on the cart 10 as the cart 10 is grasped by the lift arm 58a. Alternatively, or in addition, an RFID reader in or near the opening to the hopper 54a can read the identifier 30 on the cart 10 as the cart 10 is dumped into the hopper 54a.

The exterior camera 68 is mounted exterior of the truck 50a, such that it has a view of the cart 10 on the ground and the surrounding area before the cart 10 is grasped by the lift arm 58a. In this example, the exterior camera 68 is directed rearwardly and outwardly toward the curb. The interior camera 70 faces a portion of the hopper 54a of the truck 50a (or out from the hopper 54a) so that it has a view into the cart 10 as the lid 18 opens when the cart 10 is inverted by the lift arm 58a and into the hopper 54a so that the contents of the cart 10 are viewed by the interior camera 70 as the contents land in the hopper 54a.

The tilt switch 72 may be mounted to the lift arm 58a to indicate when the lift arm 58a has tipped the cart 10 and emptied its contents into the hopper 54a. The OBS button 74 in the cab of the truck 50a is accessible to the driver.

Referring to FIGS. 3 and 4, the CPU 76, suitably programmed, is mounted in the truck 50a and receives location information from the GPS receiver 78 and can communicate wirelessly via the communication circuit 80 (e.g. Bluetooth, wifi, and/or cell data, etc), all as before. The CPU 76 also receives inputs from the OBS button 74, the tilt switch 72, the RFID reader 64 on the rear of the truck 50a, and the RFID reader 66 on the lift arm 58a. The CPU 76 also receives and records video and/or still images from the exterior camera 68 and the interior camera 70.

Referring to both FIGS. 2 to 4, in operation, the exterior camera 68 and the interior camera 70 can be activated by the CPU 76 to record still and/or video images based upon many different triggers. Alternatively, the exterior camera 68 and interior camera 70 may capture images continuously, and the CPU 76 generates triggers that keep or mark certain images. For example, the CPU 76 may be programmed to cause the exterior camera 68 to take an image and/or the CPU 76 would store or mark the image, based upon the CPU 76 detecting any one of the following triggers:

A) Initiation of the lift arm 58/58a to lift a cart 10. An image of the cart 10 before or at engagement of the lift arm 58/58a would be taken. This may show that the cart 10 was overfilled and/or spilled prior to being lifted.

B) The driver pressing the OBS button 74 to indicate that no cart 10 was present. The image would evidence that no cart 10 was present.

C) The driver pressing the OBS button 74 to indicate that the cart 10 was present but was not able to be collected, either due to position, condition, overflowing, wrong material (e.g. trash in a recycling cart), etc. The image would show the reason that cart 10 could not be collected.

D) The truck RFID reader 64 reading an RFID identifier 30 on cart 10.

E) The lift arm RFID reader 66 reading an RFID identifier 30 on the cart 10.

The CPU 76 may also be programmed to cause the interior camera 70 to capture one or more images (or the CPU 76 keeps or marks the image(s)) based upon receiving a signal from the tilt switch 72 detecting that the lift arm 58 is dumping the cart 10 into the hopper 54. The interior camera 70 captures one or more images of the cart 10 being dumped into the hopper 54. The image captures some of the contents of the cart 10, which may be relevant to indicate non-compliant contents (e.g. garbage in a recycling cart).

All images are received by the CPU 76 and correlated with date, time, location (gps lat/long), and customer (in database—with address, name, etc). The image(s) from the cameras 68, 70 and associated information are transmitted to the server 90 where they are stored in the database 92 and associated with the profile that is associated with the specific cart 10 and/or location. For example, the images provide proof that a cart 10 was not at the associated location, was not capable of collection, or that the cart 10 was successfully collected and emptied. The images will also provide additional documentation (i.e. in addition to the gps reading and the identifier 30 reading) when a cart 10 is not at the location or address with which is it associated.

The exterior camera 68 may capture images (still and/or video) continuously which are analyzed by the CPU 76 to identify anomalies, such as garbage in a recycling cart 10 (or dumpster), overfilling of the cart 10 (or dumpster).

The exterior camera 68 may also be used to detect other anomalies, not related to trash/recycling. The fact that the truck 50 drives the same route on the same day every week may also factor into the analysis. For example, if the exterior camera 68 captures images continuously that are analyzed by the server 90, the server 90 may perform image analysis on collected images in order to:

Identify where a crosswalk would be beneficial for pedestrians. Subsequent analysis by the server 90 of images collected over time by one or more trucks 50/50a could find where people frequently cross the street;

Identify usual or unexpected crowds of people. The server 90 could flag where crowds appear regularly (more than one performance of the route) and/or identify anomalies in the locations of crowds;

Identify trash (abandoned furniture, appliances, etc) on sidewalks and street medians, such as may be caused by floods and other natural disasters (i.e. look for objects on sidewalks and medians);

Identify city code violations—e.g. high weeds, Trash/Junk/General Maintenance of the property, obstruction of sidewalk, especially if the violation persists for more than one pickup route performance (e.g. more than one week);

Identify inoperable vehicles (flat tires) or vehicles that remain parked in the same spot for more than a certain length of time (e.g. more than one route performance);

Identify areas where stray dog population exists by looking for animals in the images—again, this analysis could be performed over several performances of the route for a statistical analysis of where stray animals tend to live.

All of the image information (including date, time, location) is transmitted to the remote server 90, either in real-time over the communication circuit 80 (e.g. cell data), or it may be stored locally on the truck 50/50a and then transmitted (such as via wi-fi) to the remote server 90 when the truck 50/50a returns to the garage (or central facility).

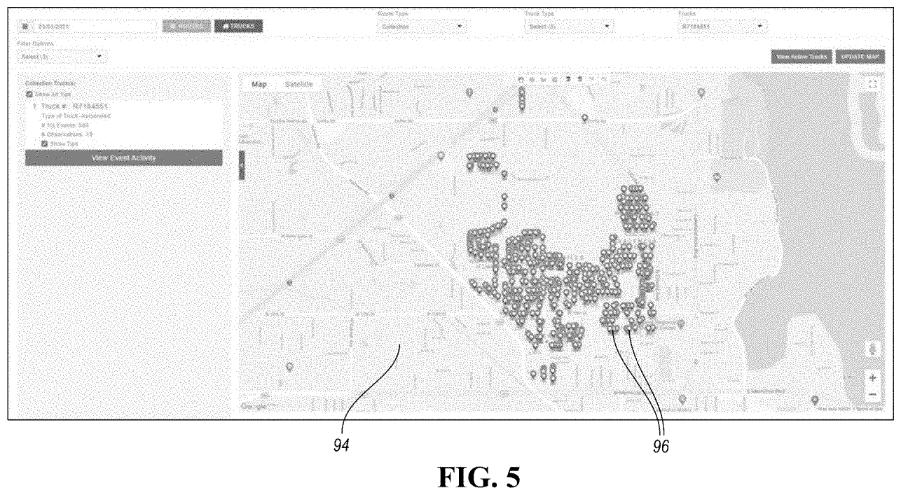

An administrative user may access the server 90, such as via a secured webpage, to obtain information collected from the trucks 50/50a. For example, referring to FIG. 5, the user may select a particular truck 50/50a and/or a particular route, and a particular date on which collections were made. In response, the server 90 provides a map display 94 to the user. The map display 94 shows the relevant geographic area, roads, landmarks, etc, and displays markers 96 on the map display 94 at locations where every event occurred on the selected day/route/truck.

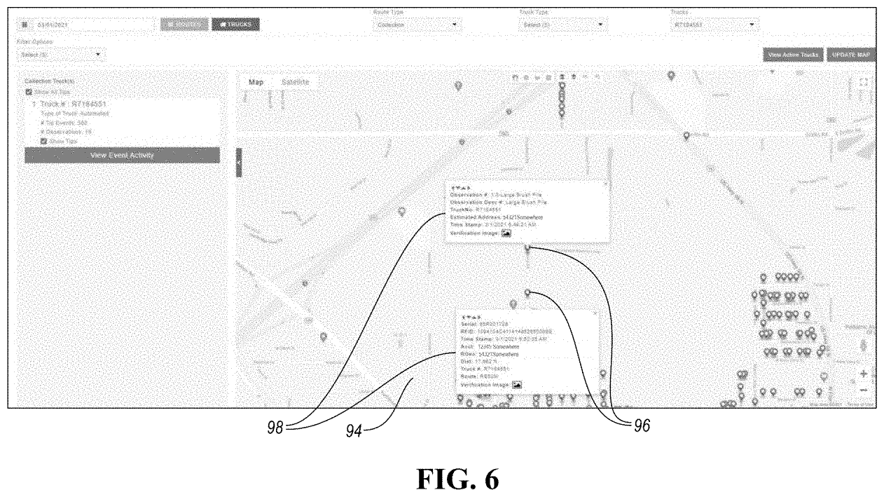

Referring to FIG. 6, the user can then select one or more markers 96. In response, the server 90 provides summary information window 98 on the map display 94 proximate the associated marker 96. The summary information window 98 provides information such as: event type (e.g. large brush pile, missing cart, improper contents, or tip (normal collection)). The summary information window 98 may also indicate the date and time of the event, the truck identification number, a proximate street address (converted from lat/long) and an image or a link to one or more verification images associated with the event, i.e. from the camera 68 and/or camera 70.

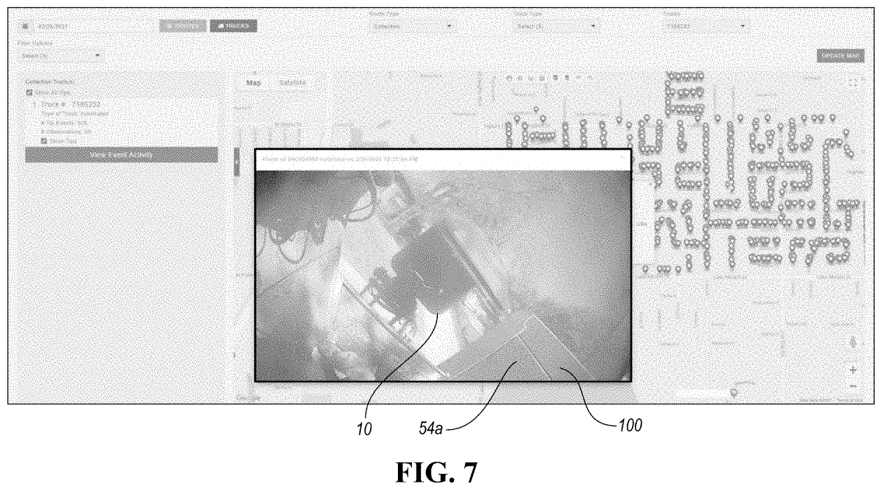

If the user clicks on the verification image link in the summary information window 98, then the server 90 causes the verification image(s) 100 associated with that event to be displayed at the user's device (computer or smart device). The verification image 100 of FIG. 7 is an example image from the interior camera 70 on the rear-loading truck 50a of FIG. 3, showing a portion of the hopper 54a and the cart 10 as it is being tipped.

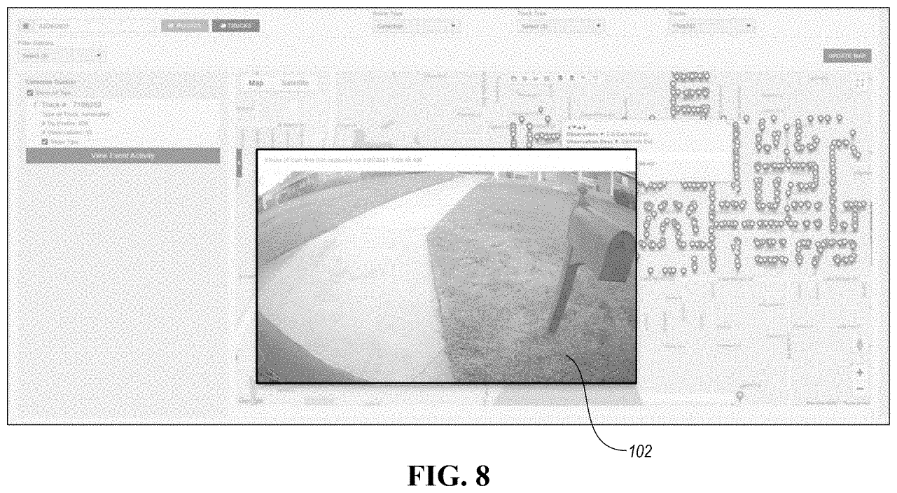

Alternatively, the user may be presented with the verification image 102 of FIG. 8. FIG. 8 is an example of an image taken by one of the exterior cameras 68 of FIG. 2 or 3, when there is no cart 10 present. The verification image 102 will help to establish that the cart 10 was not present when the truck was there to tip it.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers on method steps are solely for ease in reference in dependent claims and such identifiers by themselves do not signify a required sequence of performance, unless otherwise explicitly specified.

What is claimed is:

1. A collection vehicle comprising:
a hopper for receiving material, the hopper having an opening and an interior volume;
an RFID reader positioned proximate the opening to the hopper and configured to read an RFID tag on a container to be emptied into the hopper; and
at least one camera on the vehicle, wherein the at least one camera is positioned and oriented to image the container.

2. The collection vehicle of claim 1 wherein the at least one camera is positioned and oriented to image the container prior to the container being lifted.

3. The collection vehicle of claim 2 wherein the at least one camera is mounted exterior of the vehicle and is positioned and oriented rearward of the vehicle.

4. The collection vehicle of claim 1 further including a lift arm configured to lift the container and empty the container into the hopper.

5. The collection vehicle of claim 4 wherein the at least one camera is configured to image the container based upon movement of the lift arm.

6. The collection vehicle of claim 5 further including a CPU programmed to cause the at least one camera to image the container based upon the CPU receiving a signal indicating that the lift arm has tipped the container.

7. The collection vehicle of claim 1 further including a button activatable by a driver and wherein the at least one camera is configured to take an image based upon activation of the button.

8. The collection vehicle of claim 1 wherein the at least one camera is positioned and oriented to image the container prior to being lifted into the hopper or to image an area where the container is expected to be if no container is present.

9. The collection vehicle of claim 1 wherein the at least one camera is positioned and oriented to image the container and at least a portion of the interior volume of the hopper.

10. A service verification system comprising:
at least one collection truck including a hopper for receiving material and at least one camera positioned and oriented to image a container to be emptied into the hopper; and
at least one server receiving images from the at least one camera.

11. The service verification system of claim 10 wherein the at least one collection truck includes an RFID reader configured to read RFID tags on containers to be emptied into the hopper, the at least one server receiving identification information from the RFID reader associated with the images from the at least one camera.

12. The service verification system of claim 10 where the at least one server provides a map display of a plurality of events, wherein the events include a collection of each of a plurality of containers.

13. The service verification system of claim 12 wherein the at least one server selectively displays the images from the at least one camera.

14. The service verification system of claim 13 wherein at least one of the images shows a container missing.

15. The service verification system of claim 13 wherein at least one of the images shows a container with incorrect contents.

16. The service verification system of claim 10 wherein the at least one server analyzes the images taken over multiple collection periods.

17. A method for collecting material from containers including:
a) reading an identifier on a first container;
b) lifting the first container;
c) transferring the material from the first container to a hopper on a truck;
d) capturing a first image of the first container based upon at least one of steps a) to c); and
e) associating the first image with the first container.

18. The method of claim 17 further including the steps of:
f) after said steps a) to d), capturing a second image of an expected location where a second container is expected but missing;
g) receiving a gps location proximate the expected location; and
h) associating the gps location with second image.

19. The method of claim 17 wherein said step d) is performed based upon said step c) and wherein the first image includes at least a portion of the material from the first container.
